(19) United States
(12) Patent Application Publication
(10) Pub. No.: US 2003/0106994 A1
(43) Pub. Date: Jun. 12, 2003

(54) COVERT MARK AND SECURITY MARKING SYSTEM

(76) Inventor: IAN C SAGE, MALVERN (GB)

Correspondence Address: NIXON & VANDERHYE, 1100 NORTH GLEBE ROAD, 8TH FLOOR, ARLINGTON, VA, 222014714

(21) Appl. No.: 09/202,188

(22) PCT Filed: Jul. 7, 1997
(86) PCT No.: PCT/GB97/01763

(30) Foreign Application Priority Data
Jul. 6, 1996 (GB) 9614261.7

(51) Int. Cl. G01N 21/64

(52) U.S. Cl. 250/271; 250/458.1

(57) ABSTRACT

A covert mark (1) which may be applied to an article (2) comprises a fluorescent or phosphorescent material and has a unidirectionally aligned structure. Upon illumination of the mark (1) with ultraviolet radiation (3a), the mark (1) emits polarised fluorescent or phosphorescent radiation (3a) of characteristic radiation. The mark (1) may therefore be used in a system for covertly marking and checking the authenticity of a genuine article (2) whereby polarised fluorescent or phosphorescent radiation (3b) emitted from the mark (1) is incident on linearly polarising material. Detecting polarised fluorescent or phosphorescent radiation (3b) of characteristic wavelength and polarisation provides an indication of the authenticity of the article (2). By varying the orientation of the linearly polarising material, the plane of polarisation of radiation transmitted by the material is varied and a characteristic flashing effect is observed. The observation of fluorescent or phosphorescent radiation (3b) of characteristic wavelength in addition to the characteristic flashing effect provides an indication of the authenticity of the article (2). In an alternative arrangement, the system may comprise a liquid crystal cell, containing a twisted nematic material, to which a variable voltage is applied. The voltage applied across the liquid crystal cell may be varied to produce the required characteristic flashing effect.

This invention relates to a covert security mark which may be used in a security system for identifying genuine and counterfeit articles. The mark is covert and the system may therefore be operated covertly. It has particular (although not exclusive) relevance to the retail trade.

Counterfeiting of articles is a long standing international problem in, for example, the retail trade and credit card industry and the need for an effective means of combating counterfeiting has attracted considerable attention. One technique for indicating the authenticity of a particular article is by the use of a trademark. Such trademarks are becoming increasingly complex in design incorporating, for example, optical effects such as holograms and diffraction patterns. However, large scale counterfeiting organisations have access to considerable resources and are becoming increasingly successful at copying even the most complex marks.

Other more sophisticated anticounterfeiting measures involve the use of phosphorescent or fluorescent materials which are invisible under normal lighting but are activated when illuminated by ultra violet radiation. Properties of the fluorescent or phosphorescent radiation, for example the intensity, wavelength or the fluorescence or phosphorescence lifetime, may then be used to provide the authenticating signature. While such measures are well known as a covert means of security marking, it is possible to replicate a printed fluorophor or phosphor mark, especially considering the increasing expertise and resources of large scale anticounterfeiting organisations.

Relevant prior art is also described in U.S. Pat. No. 3,276,316, which describes a method of making a polymer sheet with an incorporated dichroic fluorescent dye which is capable of providing polarised ultraviolet fluourescent light, and in Patent Abstracts of Japan, vol. 10, no. 124(P-454), 9 May 1986 and JP 60250304 (11 Dec. 1985) which describes a polarising body comprising a layer, a fluorescent adhesive and a polarising layer.

U.S. Pat. No. 5,532,104 describes a system for reading information from a recording medium (e.g. a cover of a book) and overcomes the problem of improving the contrast of an imaged bar code. The system comprises an apparatus having a source for irradiating the recording medium with ultraviolet radiation, a polariser and a reader. The polariser is used to remove polarised fluorescent radiation from the signal received by the reader. This increases the contrast of the bar code.

The present invention relates to a covert security mark comprising a fluorescent or phosphorescent material and a security marking system in which the mark may be used. As well as having characteristic fluorescent or phosphorescent properties, the mark also has an additional polarisation property which acts as further means of authentication and makes the mark more difficult to replicate. The mark is intrinsically cheap to manufacture and easy to detect and verify.

According to the present invention, a mark for covertly marking an article comprises;

a fluorescent or phosphorescent material having an absorption band.

wherein the mark has a unidirectionally aligned structure such that upon illumination with radiation corresponding to the absorption band in the material the mark emits polarised fluorescent or phosphorescent radiation of characteristic wavelength.

According to another aspect of the invention, a system for covertly marking an article and checking its authenticity comprises;

a mark applied to the article, wherein the mark comprises a fluorescent or phosphorescent material having an absorption band and has a unidirectionally aligned structure,

a source of electromagnetic radiation for illuminating the article, wherein the wavelength of said radiation corresponds to the absorption band in the material such that upon illumination the mark emits polarised fluorescent or phosphorescent radiation of characteristic wavelength and

means for detecting the polarised fluorescent or phosphorescent radiation emitted from the mark,

whereby the detection of the polarised fluorescent or phosphorescent radiation of characteristic wavelength provides an indication of the authenticity of the article.

The source of electromagnetic radiation may be an ultra violet lamp emitting radiation between 200 nm and 400 nm. Alternatively, the source of electromagnetic radiation may be a lamp emitting short wavelength visible light between 380 nm and 550 nm.

The means for detecting the polarised fluorescent or phosphorescent radiation may include a sample of linearly polarising material having a polarisation axis substantially perpendicular to the direction of fluorescent or phosphorescent radiation.

The polarisation of fluorescent or phosphorescent radiation may be varied such that the detection of the variation in polarisation provides an indication of the authenticity of the mark.

The orientation of the sample of linearly polarising material may be varied such that the polarised fluorescent or phosphorescent radiation is detected at two or more orientations of the sample.

The system may also include;

a liquid crystal cell for transmitting the polarised fluorescent or phosphorescent radiation. wherein said liquid crystal cell is capable of rotating the plane of polarisation of the fluorescent or phosphorescent radiation transmitted through the cell and

means for applying a variable voltage across the liquid crystal cell

such that on application of the variable voltage across the cell the polarisation of fluorescent or phosphorescent radiation passing through the cell is varied.

The liquid crystal cell may comprise a twisted nematic material.

The system may also comprise;

a first retardation plate for converting the linearly polarised fluorescent or phosphorescent radiation into circularly or eliptically polarised radiation,

a second retardation plate for converting said circularly or eliptically polarised radiation into linearly polarised radiation wherein the second retardation plate is mounted in front of the means for determining the state of polarisation,

such that eliptically or circularly polarised fluorescent or phosphorescent radiation is transmitted between the first and second retardation plates.

The polarisation of fluorescent or phosphorescent radiation may be related to the intensity of radiation transmitted by the linearly polarising material. The radiation may be observed directly by the human eye or may be detected by a suitable detector. A narrow band filter may be mounted in front of the eye or the detector in order to enhance the observation or detection of the fluorescent or phosphorescent radiation of characteristic wavelength.

The mark may comprise two or more sections wherein different sections of the mark are unidirectionally aligned along different directions. Different sections of the mark may also comprise different fluorescent or phosphorescent materials.

According to another aspect of the invention, a method for producing a mark for covertly marking an article comprises the steps of;

(i) dispersing a sample of polymer in solvent at room temperature to form a viscous solution,

(ii) dispersing a fluorescent or phosphorescent material in said viscous solution to form a fluorescent or phosphorescent solution,

(iii) spreading a substantially uniform layer of fluorescent or phosphorescent solution on a substrate and drying the solution.

(iv) removing the dried layer from the substrate and heating the layer to a temperature above the glass transition point of the polymer,

(v) unidirectionally stretching the heated layer so as to produce a film having a unidirectionally aligned structure,

(vi) cooling the film to substantially room temperature and

(vii) producing marks to be applied to the genuine article from the film.

The film may be laminated to a retardation plate prior to producing marks to be applied to the genuine article. The marks may be produced from the film using a foil stamping process.

The polymer may be poly vinyl alcohol (PVA), cellulose acetate, polyethylene terephthalate (PET), polycarbonate or poly vinyl chloride (PVC). In the case of poly vinyl alcohol, the dried layer is heated to substantially 100° C.

According to another aspect of the invention, a method for covertly marking an article and checking its authenticity comprises the steps of;

(i) applying a mark to the article wherein said mark comprises a fluorescent or phosphorescent material having an absorption band and has a unidirectionally aligned structure,

(ii) illuminating the article with a source of electromagnetic radiation: wherein the wavelength of said radiation corresponds to the absorption band in the fluorescent or phosphorescent material, such that upon illumination polarised fluorescent or phosphorescent radiation of characteristic wavelength is emitted from the mark,

(iii) detecting the polarised fluorescent or phosphorescent radiation of characteristic wavelength,

whereby the detection of polarised fluorescent or phosphorescent radiation of characteristic wavelength provides an indication of the authenticity of the article.

The invention will now be described, by example only, with reference to the following figures in which;

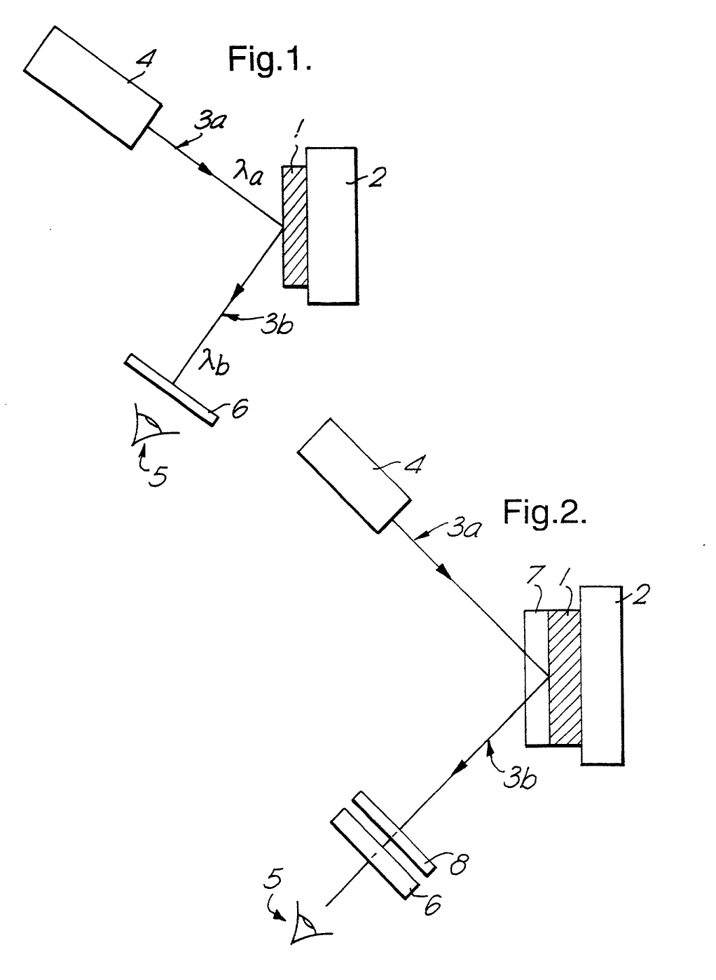

FIG. 1 shows a diagram of a security system which may be used for product identification or verification purposes and employs linearly polarised radiation

FIG. 2 shows a diagram of an alternative arrangement of the system for which circularly or eliptically polarised radiation is employed,

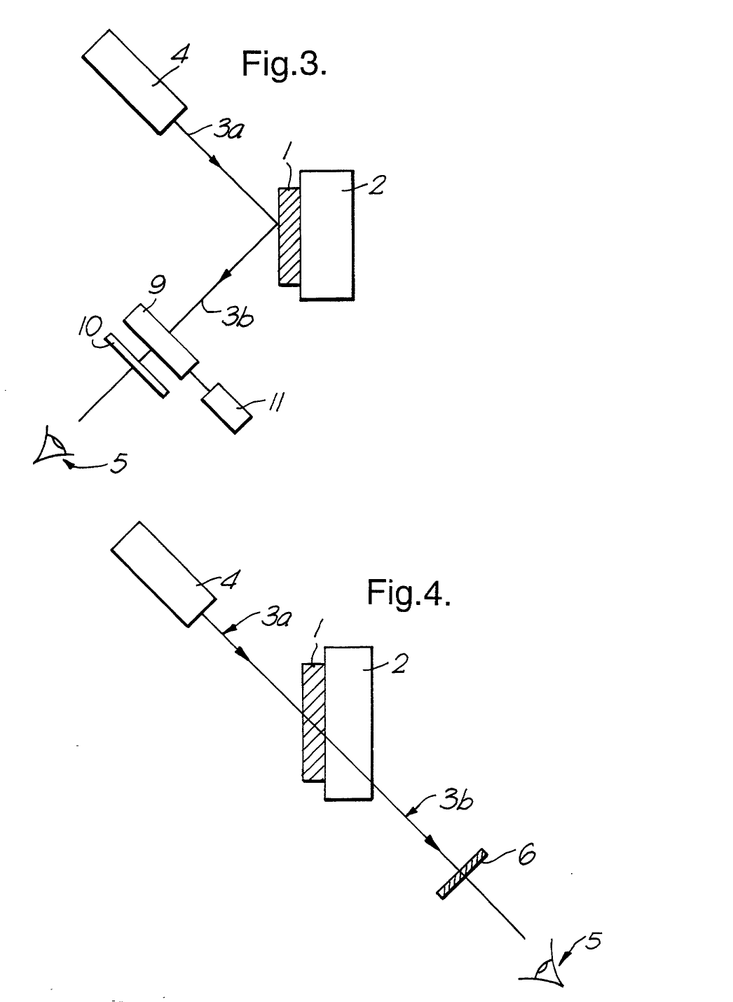

FIG. 3 shows an alternative configuration of the system, incorporating a liquid crystal cell and

FIG. 4 shows a diagram of the security system. for operation in transmission mode.

Referring to FIG. 1, a security mark 1 is applied to an article 2 which is to be authenticated. The mark comprises a fluorescent or phosphorescent material and is such that under normal lighting conditions it appears invisible to an observer. The mark 1 is illuminated with radiation 3a (wavelength=λₐ) from a radiation source 4. The radiation source 4 may be a source of ultra violet radiation emitting radiation in the wavelength region between approximately 200 mn and 400 nm and preferably between 250 nm and 380 mn. Alternatively, the source may be a lamp emitting short wavelength visible radiation in the region between 380 nm and 550 nm. For a mark comprising a fluorescent or phosphorescent material, upon illumination with the radiation 3a, fluorescent or phosphorescent radiation 3b of characteristic wavelength (λ_{b}) is emitted from the mark 1. The radiation may be observed directly by a human eye 5, as shown in the diagram, or may be detected by a suitable detector.

A narrow band filter (not shown) may be mounted in front of the detector or the eye in order to enhance the detection or observation of radiation of characteristic wavelength.

The aligned structure of the mark is such that characteristic fluorescent or phosphorescent radiation emitted from the mark is linearly polarised and the polarisation properties of the radiation are then used to provide a means for verifying the authenticity of the mark. The observation of the fluorescent or phosphorescent radiation without the required polarisation effects is not sufficient to authenticate the article.

The system may be operated with either linearly polarised radiation eliptically polarised radiation or circularly polarised radiation, the latter of which lends itself to more covert operation. Referring to FIG. 1, in the case of linearly polarised radiation, an element of linearly polarised material 6 (for example, a sheet of polariser) is placed in the path of reflected radiation 3b prior to detection. The aligned structure of the mark 1 is such that there is a strong dependence of the apparent fluorescence brightness on the orientation of the polariser.

The polarisation transmission axis of the polariser may remain fixed so that only incident radiation of a particular polarisation is transmitted by the polariser. The intensity of radiation observed may then be compared with that expected for the arrangement as a means of checking the authenticity of the mark. In this case, suitable detection means, such as a photodetector sensitive to the radiation emitted by the fluorescent or phosphorescent material, would be required to measure the intensity of radiation transmitted by the polariser.

In a preferred arrangement, the polarisation transmission axis of the polariser may be switched so that fluorescent or phosphorescent radiation of a particular polarisation is alternately transmitted and blocked by the polariser, therefore giving rise to a characteristic flashing effect. For example, rotating a polariser 6 about an axis substantially parallel to the direction of emitted radiation gives a flashing appearance to the mark 1 which may easily be recognised by the human eye. To give the desired flashing effect the polariser may be continuously rotated about this axis or may alternate between substantially orthogonal orientations. The observation of both the flashing effect in combination with the characteristic fluorescent or phosphorescent radiation provides a verification of the authenticity of the article. The characteristic effect may be an intensity variation or may be apparent as a colour variation.

Referring to FIG. 2, the mark 1 may be laminated to a retardation plate 7 for example a quarter-wave plate, and this combination is then applied to the article 2 to be authenticated. If the retardation plate is a quarter-wave plate, on passing through the plate 7 plane polarised radiation transmitted from the mark becomes circularly polarised. A second retardation plate 8 is mounted in front of the human eye, or the detection means, to convert the circularly polarised radiation back to plane polarised radiation prior to observation or detection.

Left-handed and right-handed circularly polarised radiation passing through the quarter-wave plate 8 is converted into linearly polarised radiation where the plane of polarisation of radiation output from the quarter-wave plate depends on the handedness of the radiation 3b input to the quarter-wave plate 8. By rotating the polarisation axis of the polariser 6, the amount of linearly polarised radiation transmitted by the polariser varies and gives rise to a characteristic flashing effect as described previously. Alternatively, the orientation of the retardation plate may be varied to give the same effect.

Eliptically polarised radiation may also be transmitted between the first retardation plate 7 and the second retardation plate 8 by use of suitable retardation plates.

Referring to FIG. 3, a twisted nematic liquid crystal cell 9 and a fixed sheet of linearly polarising material 10 may be used instead of a rotating polariser in order to produce the desired flashing effect. FIG. 3 shows the case where plane polarised radiation is employed but the cell 9 may also be used, in conjunction with the polariser 10, for eliptically and circularly polarised radiation.

Typically, the cell 9 comprises a conventional twisted nematic liquid crystal material contained within facing glass substrates. The inner surfaces of the glass substrates are typically coated with a transparent conducting layer (not shown), for example indium tin oxide.

Prior to assembly, the glass substrates are rubbed in a particular direction and the liquid crystal aligned along the rubbing direction near the surface of the glass. The upper substrate is aligned such that its rubbing direction is perpendicular to the rubbing direction of the lower glass substrate. Therefore, with no volts applied to the liquid crystal cell there is a continuous twist in the liquid crystal director, between the top and bottom substrates. For a twist of 90 degrees, as incident radiation passes through the liquid crystal cell its plane of polarisation is therefore rotated by 90 degrees by the twisted structure of the director.

A suitable material for use in the liquid crystal cell would be E7 nematic material plus a suitable dopant to define the pitch direction and length (e.g. 1% C15 or 0.05% CB15), available from the E. Merck catalogue. A typical thickness of the liquid crystal material would be between 6-15 μm.

The application of a switchable voltage across the cell electrodes causes the central portion of the liquid crystal to align with the field. The twisted structure no longer exists and the plane of polarisation of incoming light is not rotated as it passes through the cell. On removing the voltage, the liquid crystal material relaxes back to its twisted state. The cell is therefore switched between an OFF (twisted) and ON (not twisted) state by the application and removal of a suitable voltage.

The voltage applied across the face of the cell may be varied by means of a variable voltage source 9. By switching the voltage source 11 between “ON” and “OFF” states, only polarisation of a particular orientation will be transmitted by the polariser 10 and a flashing effect will be seen.

The mark 1 to be applied to the product 2 may be made according to the following technique. A 10 gram sample of poly vinyl alcohol, molecular weight 115,000 (commercially available from E. Merck Ltd.), is dispersed into 100 grams of water at room temperature and stirred over, typically, a 12 hour period to provide a clear, viscous solution. Typically 0.5 grams of Fluorescent Brightener 28 (commercially available from Aldrich Chemical Company, Gillingham, UK) are then added to the poly vinyl alcohol (PVA) solution. The solution is stirred again to dissolve the solid, and then allowed to stand to allow air bubbles to escape.

1. A system for covertly marking an article (2) and checking its authenticity comprising;
a mark (1) comprising a fluorescent or phosphorescent material having an absorption band, the mark having a unidirectionally aligned structure such that upon illumination with radiation corresponding to the absorption band in the material the mark emits polarised fluorescent or phosphorescent radiation of characteristic wavelength, the mark (1) being applied to the article (2),
a source (4) of electromagnetic radiation (3a) for illuminating the article (2), wherein the wavelength of said radiation (3a) corresponds to the absorption band in the material, such that upon illumination the mark emits polarised fluorescent or phosphorescent radiation (3b) of characteristic wavelength and
means (5) for detecting the polarised fluorescent or phosphorescent radiation (3b) emitted from the mark,
whereby the detection of the polarised fluorescent or phosphorescent radiation (3b) of characteristic wavelength provides an indication of the authenticity of the article (2).

2. The system of claim 1 wherein the source (4) of electromagnetic radiation is an ultra violet lamp emitting radiation between 200 nm and 400 nm.

3. The system of claim 1 wherein the source (4) of electromagnetic radiation is a lamp emitting short wavelength visible light between 380 nm and 550 nm.

4. The system of claim 1 wherein the means for detecting the polarised fluorescent or phosphorescent radiation includes a sample of linearly polarising material (6; 10).

5. The system of claim 1 wherein the sample of linearly polarised material has a polarisation axis substantially perpendicular to the direction of fluorescent or phosphorescent radiation (3b).

6. The system of any of claims 1-4 wherein the polarisation of fluorescent or phosphorescent radiation (3b) is varied and the detection of the variation in polarisation provides an indication of the authenticity of the mark.

7. The system of claim 6 wherein the orientation of the sample of linearly polarising material (6) is varied such that the polarised fluorescent or phosphorescent radiation is detected at two or more orientations of the sample (6).

8. The system of claim 6, and also including;
a liquid crystal cell (9) for transmitting the polarised fluorescent or phosphorescent radiation (3b), wherein the liquid crystal cell (9) is capable of rotating the plane of polarisation of the fluorescent or phosphorescent radiation (3b) transmitted through the cell (9) and
means (11) for applying a variable voltage across the liquid crystal cell (9),
such that on application of the variable voltage across the cell (9) the polarisation of fluorescent or phosphorescent radiation (3b) passing through the cell (9) is varied.

9. The system of claim 8 wherein the liquid crystal cell (9) comprises a twisted nematic material.

10. The system of claim 1, and also comprising;
a first retardation plate (7) for converting linearly polarised fluorescent or phosphorescent radiation (3a) into circularly or eliptically polarised radiation,
a second retardation plate (8) for converting said circularly or eliptically polarised radiation into linearly polarised radiation wherein the second retardation plate (8) is mounted in front of the means (5) for detecting the fluorescent or phosphorescent radiation (3b),
such that eliptically or circularly polarised fluorescent of phosphorescent radiation is transmitted between the first (7) and second (8) retardation plates.

11. The system of claim 10 wherein the mark (1) is laminated onto the first retardation plate (7).

12. The system of any of claims 1-4 wherein the polarisation of fluorescent or phosphorescent radiation is related to the intensity of radiation transmitted by the linearly polarising material (6; 10).

13. The system of claim 12 wherein the polarised fluorescent or phosphorescent radiation (3b) is observable by the human eye.

14. The system of claim 12, and also including a detector for detecting the polarised fluorescent or phosphorescent radiation (3b).

15. The system of claim 1 wherein the mark (1) comprises two or more sections wherein different sections of the mark are unidirectionally aligned along different directions.

16. The system of claim 1 wherein the mark comprises two or more sections wherein different sections of the mark comprise different fluorescent or phosphorescent materials.

17. The system of claim 1, and also comprising a narrow band filter for enhancing the observation or detection of fluorescent or phosphorescent radiation (3b) of characteristic wavelength emitted from the mark.

18. A method for producing a mark (1) for covertly marking an article (2) comprising the steps of;
(i) dispersing a sample of polymer in solvent at room temperature to form a viscous solution,
(ii) dispersing a fluorescent or phosphorescent material in said viscous solution to form a fluorescent or phosphorescent solution,
(iii) spreading a substantially uniform layer of fluorescent or phosphorescent solution on a substrate and drying the solution,
(iv) removing the dried layer from the substrate and heating the layer to a temperature above the glass transition point of the polymer,
(v) unidirectionally stretching the heated layer so as to produce a film having a unidirectionally aligned structure,
(vi) cooling the film to substantially room temperature and
(vii) producing marks to be applied to the genuine article from the film.

19. The method of claim 18, and also comprising the step of laminating the film to a retardation plate prior to producing marks to be applied to the genuine article.

20. The method of claims 18 or 19 wherein the marks are produced from the film using a foil stamping process.

21. The method of claim 20 wherein the polymer is poly vinyl alcohol.

22. A method for covertly marking an article (2) and checking its authenticity comprising the steps of;
(i) applying a mark (1) to the article (2), wherein said mark (1) comprises a fluorescent or phosphorescent material having an absorption band and has a unidirectionally aligned structure,
(ii) illuminating the article (2) with a source (4) of electromagnetic radiation (3a), wherein the wavelength of said radiation (3a) corresponds to the absorption band in the fluorescent or phosphorescent material, such that upon illumination polarised fluorescent or phosphorescent radiation of characteristic wavelength is emitted from the mark (1),
(iii) detecting the polarised fluorescent or phosphorescent radiation (3b) of characteristic wavelength,
whereby the detection of polarised fluorescent or phosphorescent radiation (3b) of characteristic wavelength provides an indication of the authenticity of the article (2).
